(19) United States
(12) Patent Application Publication
(10) Pub. No.: US 2016/0085916 A1
(43) Pub. Date: Mar. 24, 2016

(54) PRIVACY PRESERVING GENOME SEQUENCE MANAGEMENT

(71) Applicant: Ned M. Smith, Beaverton, OR (US)

(72) Inventor: Ned M. Smith, Beaverton, OR (US)

(21) Appl. No.: 14/494,733

(22) Filed: Sep. 24, 2014

(51) Int. Cl. G06F 19/00

(52) U.S. Cl. CPC G06F 19/322; G06F 19/3443

(57) ABSTRACT

Technologies for genomic data management include a patient device that computes an integrity register value as a function of genomic sequence data within a trusted execution environment. The genomic sequence data may not feasibly be reconstructed from the integrity register value. A genomic server computes an integrity register index of public genomic sequence data. The patient device transmits an integrity register value to the genomic server, and the genomic server responds with population data indicative of the genomic sequence data corresponding to the integrity register value. The patient device may contribute the genomic sequence data to the public genomic sequence data if the population data is sufficiently large. The patient device may also transmit the integrity register value to a research device, and the research device may respond with a compensation offer for the genomic sequence data if the population data is sufficiently small. Other embodiments are described and claimed.

### BACKGROUND

Gene sequencing and other genetic research involves the use of large datasets (i.e., containing petabytes of information) and compute-intensive operations. In particular, cancer research and other medical research may analyze the genetic sequences of many individuals. Unique or uncommon genetic sequences may be particularly useful for cancer research purposes. A person's full genome may include petabytes of data. However, only a relatively small proportion of any individual's genome (e.g., around 1.5%) may be relevant for cancer research purposes.

Personal genetic information is privacy-sensitive. An individual's genetic sequence or parts of the individual's genetic sequence may be personally identifiable. Also, the individual's genetic sequence may be used to identify or predict certain health conditions. Additionally, access to genetic sequences may be regulated by various privacy regulations, such as the Health Insurance Portability and Accountability Act (HIPAA).

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for privacy-preserving genome sequence management;

FIG. 2 is a simplified block diagram of at least one embodiment of various environments that may be established by the system of FIG. 1;

FIG. 3 is a simplified flow diagram of at least one embodiment of a method for privacy-preserving genome sequence management that may be executed by a patient computing device of the system of FIGS. 1 and 2;

FIG. 4 is a simplified flow diagram of at least one embodiment of a method for privacy-preserving genome sequence management that may be executed by a public genome server of the system of FIGS. 1 and 2;

FIG. 5 is a schematic diagram illustrating at least one embodiment of an integrity register index that may be computed by the public genome server of FIGS. 1 and 2; and

FIG. 6 is a simplified flow diagram of at least one embodiment of a method for privacy-preserving genome sequence management that may be executed by a research computing device of the system of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C): (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

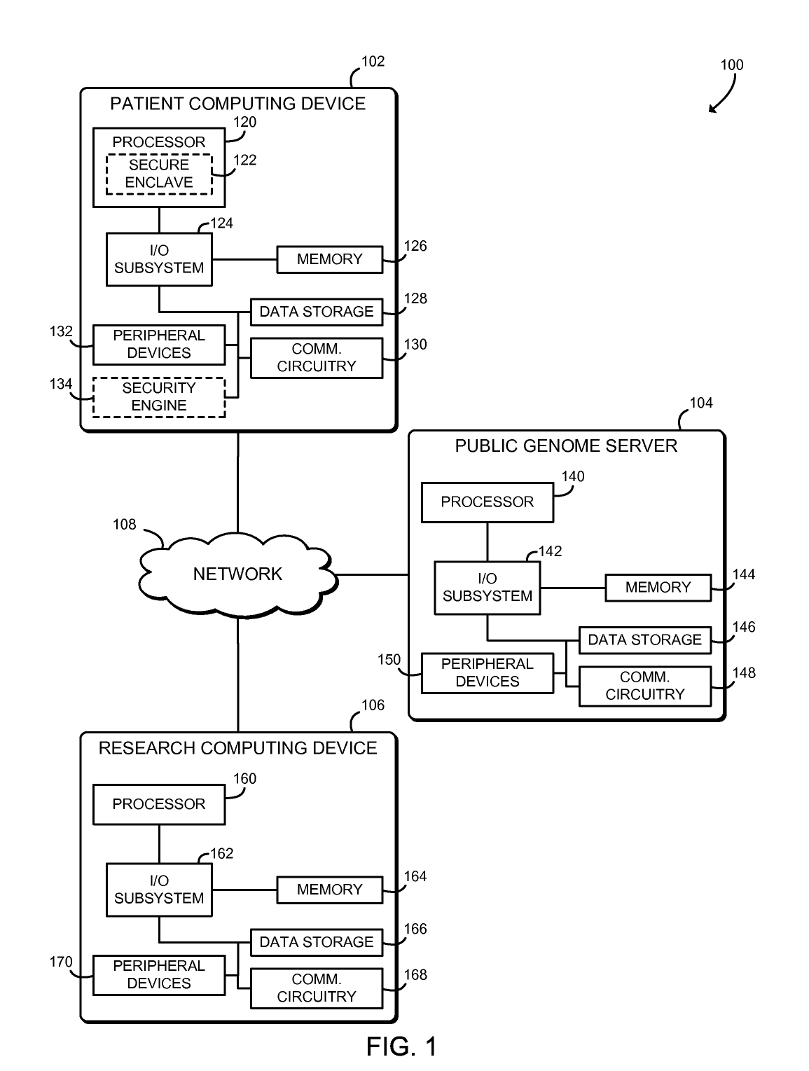

Referring now to FIG. 1, in an illustrative embodiment, a system 100 for privacy-preserving genome sequence management includes a patient computing device 102 and a public genome server 104 in communication over a network 108. In use, as described in more detail below, the patient computing device 102 generates, within a trusted execution environment, one or more integrity register values based on genome sequence data. The sequence data may correspond to the genetic information of a patient or other user of the patient computing device 102. The integrity register values correspond to the sequence data but may not feasibly be used to reconstruct the sequence data, thereby providing an amount of privacy for the patient or other user. For example, the integrity register values may be generated using a cryptographic hash function of the sequence data. Similarly, the public genome server 104 generates an index of a public genome database including reference sequence data. The public genome server 104 also maintains population data indicating the frequency of occurrence of particular sequences within a large population. The patient computing device 102 queries the public genome server 104 by supplying one or more integrity register values, and the public genome server 104 responds with the associated population data. The patient computing device 102 determines whether to publicly disclose the sequence data based on the population data, for example by determining whether the sequence data is so common that it is not likely to be personally identifying.

For unique, uncommon, or rare sequence data, or sequence data that is otherwise not publicly disclosed, the patient computing device 102 may submit a query to the research computing device 106 with one or more integrity register values. The research computing device 106 may, in some embodiments, verify that the sequence data is rare by independently querying the public genome server 104 with the integrity register values supplied by the patient computing device 102. If verified, the research computing device 106 may extend a compensation offer to the patient computing device 102. If the patient computing device 102 accepts the compensation offer, the patient computing device 102 may transmit the sequence data to the research computing device 106. Thus, the system 100 may allow the user to determine whether to contribute genetic information to a public database without first disclosing the actual sequence data. Additionally, the system 100 may allow a patient or other user to identify a relatively small subset of the patient's genomic data that is privacy-sensitive and thus better manage genomic data storage. Further, the system 100 may allow users to securely distribute genetic information to research institutions in exchange for agreed-upon compensation.

The patient computing device 102 may be embodied as any type of computation or computer device capable of performing the functions described herein, including, without limitation, a computer, a desktop computer, a workstation, a laptop computer, a notebook computer, a tablet computer, a mobile computing device, a wearable computing device, a network appliance, a web appliance, a distributed computing system, a processor-based system, and/or a consumer electronic device. As shown in FIG. 1, the patient computing device 102 illustratively includes a processor 120, an input/output subsystem 124, a memory 126, a data storage device 128, and communication circuitry 130. Of course, the patient computing device 102 may include other or additional components, such as those commonly found in a desktop computer (e.g., various input/output devices), in other embodiments. Additionally, in some embodiments, one or more of the illustrative components may be incorporated in, or otherwise form a portion of, another component. For example, the memory 126, or portions thereof, may be incorporated in one or more processors 120 in some embodiments.

The processor 120 may be embodied as any type of processor capable of performing the functions described herein. The processor 120 may be embodied as a single or multi-core processor(s), digital signal processor, microcontroller, or other processor or processing/controlling circuit. In some embodiments, the processor 120 includes secure enclave support 122. The secure enclave support 122 allows the processor 120 to establish a trusted execution environment (TEE) in which executing code may be measured, verified, or otherwise determined to be authentic. Additionally, code and data included in the TEE may be encrypted or otherwise protected from being accessed by code executing outside of the TEE. The secure enclave support 122 may be embodied as a set of processor instruction extensions that allow the processor 120 to establish one or more secure enclaves in the memory 126, which may be embodied as regions of memory including software that is isolated from other software executed by the processor 120. For example, the secure enclave support 122 may be embodied as Intel® Software Guard Extensions (SGX) technology.

The memory 126 may be embodied as any type of volatile or non-volatile memory or data storage capable of performing the functions described herein. In operation, the memory 126 may store various data and software used during operation of the patient computing device 102 such as operating systems, applications, programs, libraries, and drivers.

The memory 126 is communicatively coupled to the processor 120 via the I/O subsystem 124, which may be embodied as circuitry and/or components to facilitate input/output operations with the processor 120, the memory 126, and other components of the patient computing device 102. For example, the I/O subsystem 124 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 124 may form a portion of a system-on-a-chip (SoC) and be incorporated, along with the processors 120, the memory 126, and other components of the patient computing device 102, on a single integrated circuit chip.

The data storage device 128 may be embodied as any type of device or devices configured for short-term or long-term storage of data such as, for example, memory devices and circuits, memory cards, hard disk drives, solid-state drives, or other data storage devices. In some embodiments, the data storage device 128 may be used to store the contents of one or more trusted execution environments. When stored by the data storage device 128, the contents of the trusted execution environments may be encrypted to prevent access by unauthorized software.

The communication circuitry 130 of the patient computing device 102 may be embodied as any communication circuit, device, or collection thereof, capable of enabling communications between the patient computing device 102, the public genome server 104, the research computing device 106, and/or other remote devices over the network 108. The communication circuitry 130 may be configured to use any one or more communication technology (e.g., wired or wireless communications) and associated protocols (e.g., Ethernet, Bluetooth®, Wi-Fi®, WiMAX, etc.) to effect such communication.

In some embodiments, the patient computing device 102 may also include one or more peripheral devices 132 and a security engine 134. The peripheral devices 132 may include any number of additional input/output devices, interface devices, and/or other peripheral devices. For example, in some embodiments, the peripheral devices 132 may include a display, touch screen, graphics circuitry, keyboard, mouse, speaker system, and/or other input/output devices, interface devices, and/or peripheral devices.

The security engine 134 may be embodied as any hardware component(s) or circuitry capable of establishing a trusted execution environment (TEE) on the patient computing device 102. In particular, the security engine 134 may support executing code and/or accessing data that is independent and secure from other code executed by the patient computing device 102. The security engine 134 may be embodied as a Trusted Platform Module (TPM), a manageability engine, an out-of-band processor, or other security engine device or collection of devices. In some embodiments the security engine 134 may be embodied as a converged security and manageability engine (CSME) incorporated in a system-on-a-chip (SoC) of the patient computing device 102. Further, in some embodiments, the security engine 134 is also capable of communicating using the communication circuitry 130 or a dedicated communication circuit independently of the state of the patient computing device 102 (e.g., independently of the state of the main processor 120), also known as “out-of-band” communication.

The public genome server 104 is configured to index a public genome database and allow client computing devices (e.g., the patient computing device 102 and/or the research computing device 106) to issue queries on the public genome database. The public genome server 104 may be embodied as any type of computation or computer device capable of performing the functions described herein, including, without limitation, a computer, a multiprocessor system, a server, a rack-mounted server, a blade server, a laptop computer, a notebook computer, a tablet computer, a wearable computing device, a network appliance, a web appliance, a distributed computing system, a processor-based system, and/or a consumer electronic device. Illustratively, the public genome server 104 includes a processor 140, an I/O subsystem 142, a memory 144, a data storage device 146, communication circuitry 148, peripheral devices 150, and/or other components and devices commonly found in a server or similar computing device. Those individual components of the public genome server 104 may be similar to the corresponding components of the patient computing device 102, the description of which is applicable to the corresponding components of the public genome server 104 and is not repeated herein so as not to obscure the present disclosure. Additionally, in some embodiments, the public genome server 104 may be embodied as a “virtual server” formed from multiple computing devices distributed across the network 108 and operating in a public or private cloud. Accordingly, although the public genome server 104 is illustrated in FIG. 1 as embodied as a single server computing device, it should be appreciated that the public genome server 104 may be embodied as multiple devices cooperating together to facilitate the functionality described below.

The research computing device 106 is configured to generate compensation offers to the patient computing device 102 and manage sequence data that may be useful for medical or other research purposes. The research computing device 106 may be embodied as any type of computation or computer device capable of performing the functions described herein, including, without limitation, a computer, a multiprocessor system, a server, a rack-mounted server, a blade server, a desktop computer, a workstation, a laptop computer, a notebook computer, a tablet computer, a wearable computing device, a network appliance, a web appliance, a distributed computing system, a processor-based system, and/or a consumer electronic device. Illustratively, the research computing device 106 includes a processor 160, an I/O subsystem 162, a memory 164, a data storage device 166, communication circuitry 168, peripheral devices 170, and/or other components and devices commonly found in a workstation or similar computing device. Those individual components of the research computing device 106 may be similar to the corresponding components of the patient computing device 102, the description of which is applicable to the corresponding components of the research computing device 106 and is not repeated herein so as not to obscure the present disclosure.

As discussed in more detail below, the patient computing device 102, the public genome server 104, and the research computing device 106 may be configured to transmit and receive data with each other and/or other devices of the system 100 over the network 108. The network 108 may be embodied as any number of various wired and/or wireless networks. For example, the network 108 may be embodied as, or otherwise include, a wired or wireless local area network (LAN), a wired or wireless wide area network (WAN), a cellular network, and/or a publicly-accessible, global network such as the Internet. As such, the network 108 may include any number of additional devices, such as additional computers, routers, and switches, to facilitate communications among the devices of the system 100.

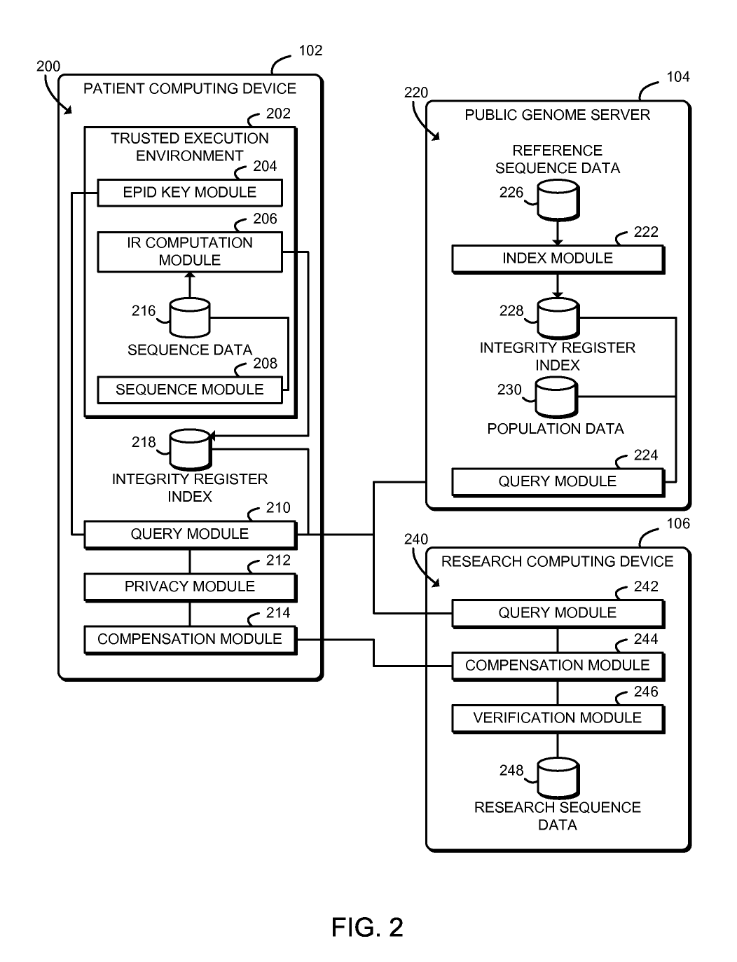

Referring now to FIG. 2, in an illustrative embodiment, the patient computing device 102 establishes an environment 200 during operation. The illustrative environment 200 includes a trusted execution environment 202, a query module 210, a privacy module 212, and a compensation module 214. The various modules of the environment 200 may be embodied as hardware, firmware, software, or a combination thereof. For example the various modules, logic, and other components of the environment 200 may form a portion of, or otherwise be established by, the processor 120 or other hardware components of the patient computing device 102.

The trusted execution environment 202 is configured to provide an isolated and secure execution environment within the environment 200. In some embodiments, the trusted execution environment 202 may be embodied as a software-based trusted execution environment; that is, a trusted execution environment that securely executes software using the processor 120 of the patient computing device 102. For example, the trusted execution environment 202 may be embodied as one or more secure enclaves established using the secure enclave support 122 of the processor 120, such as a secure enclave established using Intel® SGX technology. Additionally or alternatively, the trusted execution environment 202 may be embodied as a hardware-based trusted execution environment; that is, a trusted execution environment that securely executes independently of software executed by the processor 120. For example, the trusted execution environment 202 may be embodied using a coprocessor, out-of-band processor, or other component of the security engine 134. The trusted execution environment 202 further establishes an enhanced privacy identification (EPID) key module 204, an integrity register computation module 206, and a sequence module 208. The various modules of the trusted execution environment 202 may be embodied as hardware, firmware, software, or a combination thereof.

The EPID key module 204 is configured to securely store an EPID key that may be used to open an anonymous authenticated connection with the public genome server 104. The EPID key module 204 may encrypt, isolate, or otherwise protect the EPID key from unauthorized access outside of the trusted execution environment 202.

The integrity register computation module 206 is configured to compute one or more integrity register values based on the sequence data 216 stored within the trusted execution environment 202. The integrity register values are stored within an integrity register index 218. The sequence data 216 includes data elements that represent genome data of the patient or other individual associated with the patient computing device 102. For example the sequence data 216 may include one or more sequences of DNA bases (e.g., A, T, C, and G). The integrity register values are generated as a function of the sequence data 216, but may not feasibly be used to reconstruct the actual sequence data 216. For example, the integrity register index 218 may include one or more cryptographic hashes generated as a function of the sequence data 216.

The sequence module 208 is configured to securely transmit the sequence data 216 to the research computing device 106 when the patient elects to contribute the sequence data 216. Because the sequence module 208 is established by the trusted execution environment 202, the sequence data 216 may be transmitted to the research computing device 106 without exposure to other components of the patient computing device 102 located outside the trusted execution environment 202.

The query module 210 is configured to transmit a query including one or more integrity register values to the public genome server 104 and receive population data in response to the query. The integrity register values correspond to particular sequences of the sequence data 216. The population data indicates the number of individuals having sequence data 216 corresponding to the queried integrity register values. Common genetic sequences may tend to have large numbers of individuals having matching sequence data 216.

The privacy module 212 is configured to determine whether to contribute the sequence data 216 to the public genome server 104 based on the privacy preferences of the patient. The privacy module 212 may evaluate the population data received from the public genome server 104 to determine whether to contribute the sequence data 216. The privacy module 212 may also instruct the public genome server 104 to increment population data associated with the sequence data 216 when contributing the sequence data 216 to the public genome server 104.

The compensation module 214 is configured to receive a compensation offer from the research computing device 106 and determine whether to accept the offer. As described further below, the research computing device 106 may extend a compensation offer if the sequence data 216 is rare or otherwise likely to be useful for research purposes.

Still referring to FIG. 2, in the illustrative embodiment, the public genome server 104 establishes an environment 220 during operation. The illustrative environment 220 includes an index module 222 and a query module 224. The various modules of the environment 220 may be embodied as hardware, firmware, software, or a combination thereof. For example the various modules, logic, and other components of the environment 220 may form a portion of, or otherwise be established by, the processor 140 or other hardware components of the public genome server 104.

The index module 222 is configured to generate an integrity register index 228 as a function of reference sequence data 226. The reference sequence data 226 includes data elements representing publicly available genetic sequence data. For example, the reference sequence data 226 may be embodied as or otherwise include the HG19 reference genome or other reference genome widely used in medical or genetic research. The integrity register index 228, similar to the integrity register index 218, represents the reference sequence data 226, but may not be used to reconstruct the reference sequence data 226. For example, the integrity register index 228 may include one or more cryptographic hashes generated as a function of the reference sequence data 226. The integrity register index 228 is associated with population data 230. The population data 230 represents the number of individuals in a large population (e.g., the general population) having sequence data 216 corresponding to the associated integrity register value(s). The population data 230 may be embodied as a population counter associated with each integrity register value of the integrity register index 228.

The query module 224 is configured to receive queries from the patient computing device 102 and/or the research computing device 106, search the integrity register index 228 and determine population data 230 based on the query, and transmit the population data 230 to the patient computing device 102 and/or the research computing device 106 in response to the query. The received queries include one or more integrity register values that may be compared to values of the integrity register index 228. The query module 224 may also increment the population data 230 associated with the queried integrity register values in response to the query.

Still referring to FIG. 2, in the illustrative embodiment, the research computing device 106 establishes an environment 240 during operation. The illustrative environment 240 includes a query module 242, a compensation module 244, and a verification module 246. The various modules of the environment 240 may be embodied as hardware, firmware, software, or a combination thereof. For example the various modules, logic, and other components of the environment 240 may form a portion of, or otherwise be established by, the processor 160 or other hardware components of research computing device 106.

The query module 242 is configured to receive queries from the patient computing device 102. The received queries include one or more integrity register values representing sequence data 216 of the patient computing device 102. The query module 242 may also be configured to transmit queries to the public genome server 104, similar to the query module 210 of the patient computing device 102.

The compensation module 244 is configured to transmit a compensation offer to the patient computing device 102 in response to receiving the integrity register values. The compensation offer may include any monetary or non-monetary compensation offered to the patient for use of the sequence data 216. The compensation offer may be determined based on the relative value of the sequence data 216 for research purposes. In response to transmitting the compensation offer, the compensation module 244 receives the sequence data 216 from the patient computing device 102. The received sequence data 216 is incorporated into research sequence data 248, and may be used for medical research or other research purposes. In some embodiments, the research sequence data 248 may be encrypted, partitioned, protected, or otherwise isolated to preserve user privacy.

The verification module 246 is configured to transmit the one or more integrity register values received from the patient computing device 102 to the public genome server 104. The verification module 246 may transmit the integrity register values via an authenticated connection. The verification module 246 is further configured to receive population data from the public genome server 104 indicative of the number of individuals having sequence data 216 corresponding to the integrity register values. The verification module 246 determines whether to transmit the compensation offer to the patient computing device 102 based on the population data. For example, the population data may be used by the verification module 246 to verify that the integrity register values are associated with sequence data 216 that is rare or otherwise useful for research purposes.

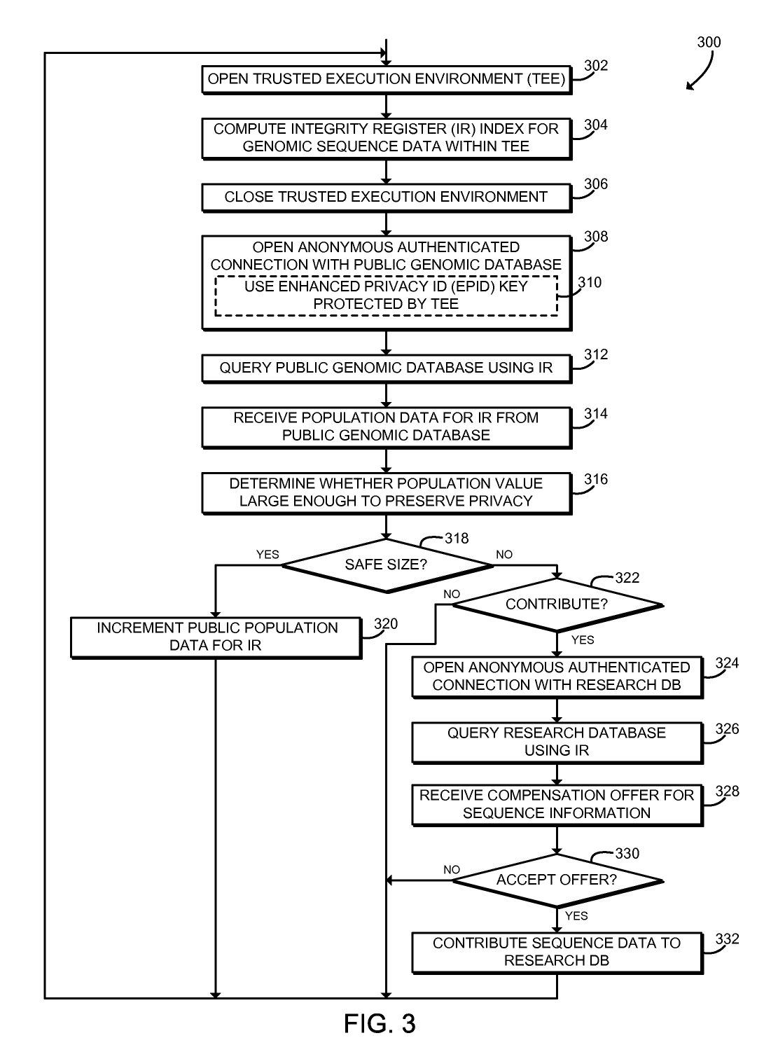

Referring now to FIG. 3, in use, the patient computing device 102 may execute a method 300 for privacy-preserving genome sequence management. The method 300 begins with block 302, in which the patient computing device 102 opens the trusted execution environment 202. The patient computing device 102 may use any appropriate technique to open the trusted execution environment 202. For example, the patient computing device 102 may establish one or more secure enclaves within the memory 126 using the secure enclave support 122 of the processor 120. To establish a secure enclave, the patient computing device 102 may execute one or more processor instructions to create the secure enclave, add memory pages to the secure enclave, and finalize measurements of the secure enclave. The secure enclave may be established, for example, using Intel® SGX technology. Additionally or alternatively, the patient computing device 102 may open the trusted execution environment 202 using a coprocessor, out-of-band processor, or other component of the security engine 134. For example, in some embodiments, the patient computing device 102 may generate a network request, local socket connection, HECI bus message, or other message to the security engine 134 to open the trusted execution environment 202.

In block 304, the patient computing device 102 computes the integrity register index 218 for the sequence data 216, within the trusted execution environment 202. The patient computing device 102 may calculate the integrity register index 218 by calculating one or more cryptographic hashes for part or all of the sequence data 216. The integrity register index 218 is illustratively calculated using the SHA256 cryptographic hash function, but in other embodiments may be calculated using any cryptographic hash function. In some embodiments, the integrity register index 218 may be calculated using hardware support of the patient computing device 102, for example using one or more cryptographic functions provided by the security engine 134. As further described below, the integrity register index 218 may be communicated with other devices such as the public genome server 104 and/or the research computing device 106, without revealing the contents of the sequence data 216. Thus, the sequence data 216 may remain isolated or otherwise protected from access by code outside of the trusted execution environment 202.

The integrity register index 218 may be calculated as a function of the sequence data 216 and previous integrity register index values. Thus, the integrity register index 218 may incorporate computation and checking of combinations of sequences. For example, the sequence data 216 may include one or more sequences of DNA bases (i.e., A, C, T, and G) for each chromosome of the human genome. Each sequence of bases may be represented as a sequence of values b₀, b₁, . . . , bₙ. An integrity register value IR may be calculated as shown in Equation 1, below. As shown, the integrity register value IRᵢ is calculated as a hash function h( ) of the previous integrity register value IRᵢ₋₁ concatenated with the appropriate base value bᵢ. (Prior to processing the sequence data, the integrity register may be initialized to some known value IR₋₁, such as zero.) Thus, the ending value of the integrity register depends on the sequence of bases, and the sequence of bases may not be reconstructed from the integrity register value (other than by computationally intensive random guessing and checking) The integrity register index 218 may store one or more integrity register values for each sequence; for example, the integrity register index 218 may store a primary integrity register value for the complete sequence and several secondary integrity registers for partial sequences within the complete sequence.

IRᵢ=h(IRᵢ₋₁,bᵢ) (1)

In block 306, the patient computing device 102 closes the trusted execution environment 202. After closing the trusted execution environment 202, the sequence data 216 may remain isolated or otherwise protected from access by the patient computing device 102. The patient computing device 102 may use any appropriate technique to close the trusted execution environment 202. In some embodiments, for example when the trusted execution environment 202 is established by the security engine 134, the trusted execution environment 202 may remain available after being closed, but may not perform further processing of the integrity register index 218.

In block 308, the patient computing device 102 opens an anonymous authenticated connection with the public genome server 104. The patient computing device 102 may use any technique to open an authenticated connection that preserves the anonymity of the patient and/or other individual associated with the sequence data 216. For example, the patient computing device 102 may open a connection using the Sign-and-MAC (SIGMA) protocol. In some embodiments, in block 310 the patient computing device 102 may authenticate the connection using an enhanced privacy identification (EPID) key protected by the trusted execution environment 202. EPID keys may be associated with a group having a single public EPID key and a particular group identification (Group ID or GID). Any private EPID key, of which there may be many, belonging to that group may be paired with a corresponding public EPID key as a valid public-private cryptographic pair. For example, the security engine 134 (or trusted execution environment 202) of the patient computing device 102 may be bound to a private EPID key. Additionally, EPID keys allow both anonymity and unlinkability of the members, and also allow key revocation. In other embodiments, another one-to-many cryptographic scheme may be used.

In block 312, the patient computing device 102 queries the public genome server 104 using the integrity register index 218. The patient computing device 102 may transmit one or more integrity register values from the integrity register index 218 to the public genome server 104. Those integrity register values are associated with particular sequences of the sequence data 216. The patient computing device 102 may query the public genome server 104 via the anonymous authenticated connection, via an encrypted connection, or via another secure communication channel.

In block 314, the patient computing device 102 receives population data from the public genome server 104 in response to the query. As described further below, the public genome server 104 matches the integrity register value supplied by the patient computing device 102 against the integrity register index 228. The public genome server 104 then determines whether the supplied integrity register value is found in the integrity register index 228, and how common the supplied integrity register value is in the general population based on the population data 230; that is, how many individuals have genome sequence data 216 corresponding to the supplied integrity register value. Thus, in some embodiments, the population data received from the public genome server 104 may be embodied as the population data 230 associated with integrity register values of the integrity register index 228 that match the supplied integrity register values.

In block 316, the patient computing device 102 determines whether the population count indicated by the population data is large enough to preserve the patient's privacy. If a particular genetic sequence is found in many other individuals, that genetic sequence may not be used to identify any particular individual having that sequence. Thus, the patient computing device 102 may compare the population value to a predefined threshold population value (e.g., one million individuals) and determine whether the population value exceeds the threshold. The particular threshold used to determine whether a genetic sequence is common enough to preserve the patient's privacy may be configured or otherwise determined based on the individual patient's privacy preferences. In block 318, the patient computing device 102 determines whether the population data indicates that the population size is safe to preserve privacy. If not, the method 300 branches to block 322, described below. If the population value is of a safe size, the method 300 branches to block 320.

In block 320, the patient computing device 102 increments the population data 230 associated with the integrity register value or values supplied with the query to the public genome server 104, as described above in connection with block 312. The patient computing device 102 may send a message or otherwise instruct the public genome server 104 to increment the population data 230 associated with the supplied integrity register values. Incrementing the population data 230 indicates that another individual—the patient—has genetic sequence data 216 corresponding to the supplied integrity register values. Thus, the population data 230 maintained by the public genome server 104 may be updated based on the sequence data 216, without actually transmitting the sequence data 216 to the public genome server 104. After incrementing the population data, the method 300 loops back to block 302 to continue computing the integrity register index 218.

Referring back to block 318, if the population value is not of safe size (e.g., less than the threshold population value), then the method branches to block 322. In that scenario, one or more sequences within the sequence data 216 may be rare within the general population and thus may be useful for cancer research or other genetic research. In block 322, the patient computing device 102 determines whether to contribute the sequence data 216 to the research computing device 106 for research purposes. The patient computing device 102 may determine whether to contribute the sequence data 216 based on user preferences or any other appropriate criteria. If the patient computing device 102 determines not to contribute the sequence data 216, then the method 300 loops back to block 302 to continue computing the integrity register index 218. If the patient computing device 102 determines to contribute the sequence data 216, the method 300 advances to block 324.

In block 324 the patient computing device 102 opens an anonymous authenticated connection with the research computing device 106. Similar to the anonymous authenticated connection described above in connection with block 308, the patient computing device 102 may use any technique to open an authenticated connection that preserves the anonymity of the patient and/or other user, such as a SIGMA protocol connection. Although illustrated as connecting with a single research computing device 106, it should be understood that in some embodiments the patient computing device 102 may contact several research computing devices 106.

In block 326, the patient computing device 102 queries the research computing device 106 using the integrity register index 218. The patient computing device 102 may transmit one or more integrity register values from the integrity register index 218 to the research computing device 106. Those integrity register values may be associated with particular sequences of the sequence data 216 that are rare in the general population, as indicated by the population data received from the public genome server 104. The patient computing device 102 may query the research computing device 106 via the anonymous authenticated connection, via an encrypted connection, or via another secure communication channel.

In block 328, the patient computing device 102 may receive a compensation offer for the sequence information from the research computing device 106. The compensation offer may specify monetary compensation or any other compensation offered by a research organization or other entity for access to the sequence data 216. In some embodiments, as described below, prior to transmitting the compensation offer, the research computing device 106 may verify the population data associated with the supplied integrity register values by querying the public genome server 104.

In block 330, the patient computing device 102 determines whether to accept the offer of compensation. The patient computing device 102 may use any criteria to determine whether to accept the offer. For example, the patient computing device 102 may present the offer to the patient and determine whether to accept the offer based on input from the patient. If the offer is not accepted, the method 300 loops back to block 302 to continue computing the integrity register. If the offer is accepted, the method 300 advances to block 332.

In block 332, the patient computing device 102 contributes the sequence data 216 to the research computing device 106. The patient computing device 102 may transmit (or otherwise grant access to) the sequence data 216 itself to the research computing device 106, rather than supplying only the integrity register index 218. The patient computing device 102 may protect the sequence data 216 by transmitting the sequence data 216 over an encrypted connection, transmitting the sequence data 216 from the trusted execution environment 202, or otherwise isolating or protecting the sequence data 216. After contributing the sequence data 216, the method 300 loops back to block 302 to continue computing the integrity register.

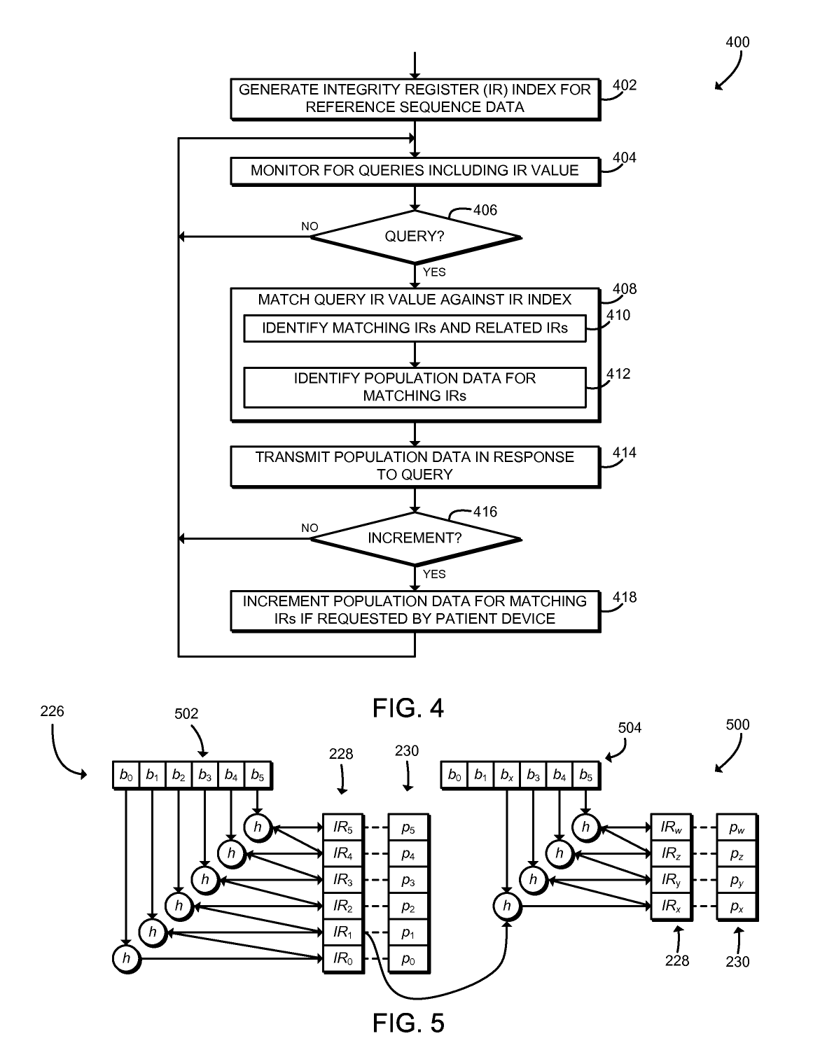

Referring now to FIG. 4, in use the public genome server 104 may execute a method 400 for privacy-preserving genome sequence management. The method 400 begins with block 402, in which the public genome server 104 generates the integrity register index 228 for the reference sequence data 226. The public genome server 104 may compute the integrity register index 228 by calculating one or more cryptographic hashes for part or all of the reference sequence data 226, similar to the calculation of the integrity register index 218 as described above in connection with block 304.

The reference sequence data 226 may include several branches or alternative sequences, for example associated with mutations. The public genome server 104 may compute and store integrity register values for each branch. Referring now to FIG. 5, a schematic diagram 500 illustrates one potential embodiment of the integrity register index 228 storing data for multiple branches of the reference sequence data 226. In the illustrative example, the reference sequence data 226 includes a main sequence 502 of data elements that represent bases of the reference sequence data 226 (b₀, b₁, b₂, b₃, b₄, b₅). The reference sequence data 226 also includes a mutant branch 504 in which the element b₂ is replaced with bₓ. As shown, the integrity register index 228 includes integrity register values IRᵢ, which are equal to h(IRᵢ₋₁, bᵢ). For example, for the main sequence 502, the integrity register value IR₁ equals the hash function h of the value IR₀ concatenated with the base value b₁, the integrity register value IR₂ equals the hash function h of the value IR₁ concatenated with the base value b₂, and so on. For the mutant branch 504, the integrity register values IR₀ and IR₁ are the same as for the main branch 502. Starting with the mutated element bₓ, the integrity register value IRₓ equals h(IR₁, bₓ), the integrity register value IR_{y} equals h(IRₓ, b₃), and so on. Thus, the integrity register index 228 may store the integrity register value IR₁ associated with the pre-branch sequence (b₀, b₁), as well as both the integrity register values IR₂ and IRₓ, associated with the main branch 502 and the mutant branch 504, respectively. Thus, the integrity register index 228 may be used to search the reference sequence data 226, and may be used to identify sub-sequences, mutant branches, and other relationships between sequences. Additionally, as shown each integrity register value IRᵢ is associated with a population counter value pᵢ (e.g., IR₀ is associated with p₀, IR₁ is associated with p₁, and so on). Accordingly, those population counter values may be used to store and/or determine population data at a per-integrity register value level of granularity.

Referring back to FIG. 4, in block 404 the public genome server 104 monitors for queries including one or more requested integrity register values. The public genome server 104 may monitor for queries from any client computing device, for example from a patient computing device 102 or from a research computing device 106. The public genome server 104 may receive the query via an anonymous authenticated connection as described above in connection with block 308 of FIG. 3. In block 406, the public genome server 104 determines whether a query has been received. If not, the method 400 loops back to block 404 to continue monitoring for queries. If a query has been received, the method 400 advances to block 408.

In block 408, the public genome server 104 matches the queried integrity register values against the integrity register index 228. In block 410, the public genome server 104 identifies matching integrity register values in the integrity register index 228 and relationships between those integrity registers. For example, the public genome server 104 may identify matching integrity register values associated with a mutant branch and pre-branch sequence. In block 412, the public genome server 104 identifies population data 230 associated with matching integrity register values. As described above, the population data 230 indicates the number of individuals in a large population that have sequence data 216 corresponding to matching integrity register values. Of course, in some circumstances the query integrity register values may not match any values in the integrity register index 228; in those circumstances, the population data may indicate a population of zero.

In block 414, the public genome server 104 transmits the population data 230 in response to the query. As described above in connection with FIG. 3, the patient computing device 102 may evaluate the population data to determine whether to publicly contribute sequence data 216 to the reference sequence data 226. As further described below, the research computing device 106 may also process the population data.

In block 416, the public genome server 104 determines whether to increment population data 230 associated with the query integrity register values. The public genome server 104 may increment the population data 230, for example, in response to a request to increment the population data 230 received from the patient computing device 102. If the public genome server 104 determines not to increment the population data 230, the method 400 loops back to block 404 to continue monitoring for queries. If the public genome server 104 determines to increment the population data 230, the method 400 advances to block 418, in which the public genome server 104 increments the population data 230 associated with the queried integrity register values. After incrementing the population data 230, the method 400 loops back to block 404 to continue monitoring for queries.

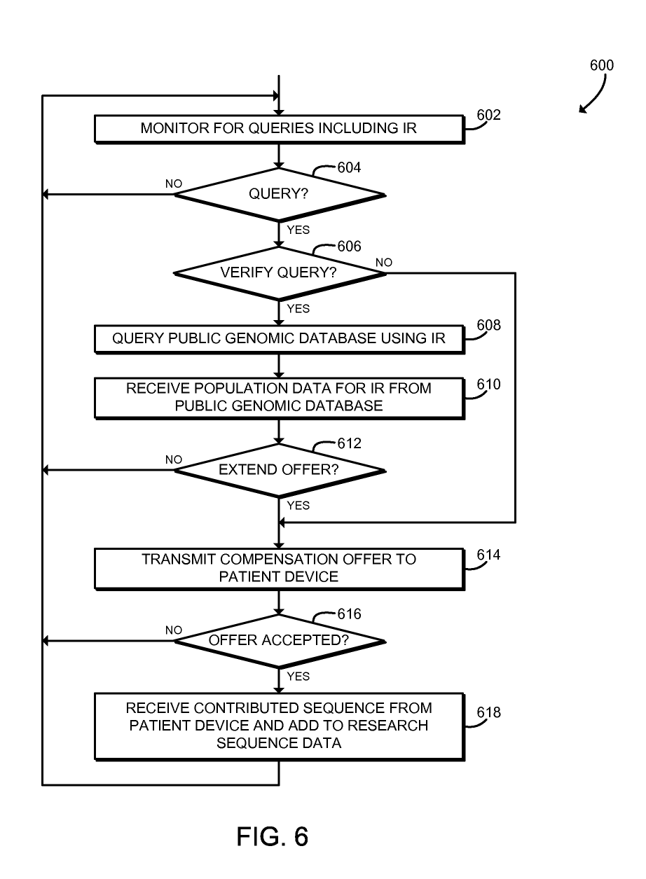

Referring now to FIG. 6, in use the research computing device 106 may execute a method 600 for privacy-preserving genome sequence management. The method 600 begins with block 602, in which the research computing device 106 monitors for queries from the patient computing device 102 including one or more requested integrity register values. The research computing device 106 may receive the query via an anonymous authenticated connection as described above in connection with block 324 of FIG. 3. As described above, the patient computing device 102 may transmit the query when the sequence data 216 is not found in the reference sequence data 226 or is otherwise rare. In block 604, the research computing device 106 determines whether a query has been received. If not, the method 600 loops back to block 602 to continue monitoring for queries. If a query has been received, the method 600 advances to block 606.

In block 606, the research computing device 106 determines whether to verify the query received from the patient computing device 102. The research computing device 106 may use any criteria to determine whether to verify the query. For example, the research computing device 106 may be pre-configured to verify all or some queries. If the research computing device 106 determines not to verify the query, the method 600 branches ahead to block 614, described below. If the research computing device 106 determines to verify the query, the method 600 advances to block 608.

In block 608, the research computing device 106 queries the public genome server 104 using the integrity register values received from the patient computing device 102. The research computing device 106 may query the public genome server 104 via an anonymous authenticated connection, an encrypted connection, or another secure communication channel, similar to the anonymous authenticated connection described above in connection with block 312 of FIG. 3.

In block 610, the research computing device 106 receives population data from the public genome server 104 in response to the query. As described above in connection with FIG. 4, the public genome server 104 matches the integrity register value supplied by the research computing device 106 against the integrity register index 228. The public genome server 104 then determines whether the supplied integrity register value is found in the integrity register index 228. If found, the public genome server 104 determines how common the supplied integrity register value is in the general population based on the population data 230; that is, the public genome server 104 determines how many individuals have genome sequence data 216 corresponding to the supplied integrity register value.

In block 612, the research computing device 106 determines whether to extend a compensation offer to the patient computing device 102 based on the population data received from the public genome server 104. The research computing device 106 may extend a compensation offer, for example, if the population data indicates that the sequence data 216 of the patient computing device 102 is sufficiently rare or for some other research or business reason. For example, the research computing device 106 may compare the population data to a predefined threshold population value, and extend a compensation offer if the population data is below the threshold. If an offer is not extended, the method 600 loops back to block 602 to continue monitoring for queries from the patient computing device 102. If an offer is to be extended, the method 600 advances to block 614.

In block 614, the research computing device 106 extends a compensation offer to the patient computing device 102. As described above in connection with block 328 of FIG. 3, the compensation offer may specify monetary compensation or any other compensation offered for access to the sequence data 216 by a research organization or other entity in control of the research computing device 106. In block 616, the research computing device 106 determines whether the offer was accepted by the patient computing device 102. The research computing device 106 may, for example, receive a message or other communication from the patient computing device 102 indicating the compensation offer was accepted. If the compensation offer was not accepted, the method 600 loops back to block 602 to continue monitoring for queries from the patient computing device 102. If the compensation offer was accepted, the method 600 advances to block 618.

In block 618, the research computing device 106 receives contributed sequence data 216 from the patient computing device 102, and adds the received sequence data 216 to the research sequence data 248. The contributed sequence data 216 corresponds to the integrity register values previously received from the patient computing device 102. Thus, the contributed sequence data 216 may be rare or otherwise useful for research purposes. The research computing device 106 may encrypt, isolate, or otherwise protect the research sequence data 248, to preserve the privacy of the patient. After receiving the contributed sequence data 216, the method 600 loops back to block 602 to continue monitoring for queries from the patient computing device 102.

### EXAMPLES

Illustrative examples of the technologies disclosed herein are provided below. An embodiment of the technologies may include any one or more, and any combination of, the examples described below.

Example 1 includes a computing device for genomic data management, the computing device comprising an integrity register computation module to compute, in a trusted execution environment, an integrity register value as a cryptographic function of genomic sequence data; a query module to (i) transmit the integrity register value to a public genomic database server and (ii) receive, from the public genome database server and in response to transmission of the integrity register value, population data indicative of a number of individuals having the genomic sequence data corresponding to the integrity register value; and a privacy module to determine whether to contribute the genomic sequence data to the public genomic database based on the population data.

Example 2 includes the subject matter of Example 1, and wherein to compute the integrity register value comprises to concatenate a next element of the genomic sequence data and a previous integrity register value to generate a concatenated value; and compute the integrity register value as a cryptographic function of the concatenated value.

Example 3 includes the subject matter of any of Examples 1 and 2, and wherein to compute the integrity register value comprises to apply a cryptographic hash function to the concatenated value.

Example 4 includes the subject matter of any of Examples 1-3, and wherein to determine whether to contribute the genomic sequence data comprises to compare the population data to a predefined threshold population value.

Example 5 includes the subject matter of any of Examples 1-4, and wherein the integrity register computation module is further to compute a second integrity register value as a cryptographic function of second genomic sequence data, wherein the second genomic sequence data includes the genomic sequence data; the query module is further to (i) transmit the second integrity register value to the public genomic database server and (ii) receive, from the public genome database server and in response to transmission of the second integrity register value, second population data indicative of a number of individuals having the second genomic sequence data corresponding to the second integrity register value; and the privacy module is further to determine whether to contribute the second genomic sequence data to the public genomic database based on the second population data, wherein to determine whether to contribute the second genomic sequence data comprises to compare the second population data to the predefined threshold population value.

Example 6 includes the subject matter of any of Examples 1-5, and wherein the privacy module is further to instruct the public genomic database server to increment the population data associated with the integrity register value in response to a determination to contribute the genomic sequence data to the public genomic database.

Example 7 includes the subject matter of any of Examples 1-6, and further including a processor having a secure enclave, the secure enclave to establish the trusted execution environment.

Example 8 includes the subject matter of any of Examples 1-7, and further including a security engine to establish the trusted execution environment.

Example 9 includes the subject matter of any of Examples 1-8, and wherein the security engine comprises a trusted platform module.

Example 10 includes the subject matter of any of Examples 1-9, and wherein the security engine comprises a converged security and manageability engine.

Example 11 includes the subject matter of any of Examples 1-10, and wherein the query module is further to open an authenticated connection with the public genomic database server; and to transmit the integrity register value to the public genomic database comprises to transmit the integrity register value via the authenticated connection.

Example 12 includes the subject matter of any of Examples 1-11, and wherein to open the authenticated connection comprises to open the authenticated connection using an encryption key protected by the trusted execution environment.

Example 13 includes the subject matter of any of Examples 1-12, and wherein the encryption key comprises an enhanced privacy identification (EPID) key.

Example 14 includes the subject matter of any of Examples 1-13, and further including a compensation module to receive a compensation offer from a research database server; determine whether to accept the compensation offer; and transmit the genomic sequence data to the research database server in response to a determination to accept the compensation offer; wherein the query module is further to transmit the integrity register value to the research database server.

Example 15 includes the subject matter of any of Examples 1-14, and wherein to transmit the genomic sequence data comprises to transmit the genomic sequence data by the trusted execution environment of the computing device.

Example 16 includes the subject matter of any of Examples 1-15, and wherein the query module is further to open an authenticated connection with the research database server; and to transmit the genomic sequence data comprises to transmit the genomic sequence data via the authenticated connection.

Example 17 includes a computing device for genomic data management, the computing device comprising an index module to generate an integrity register index as a cryptographic function of public genomic sequence data, wherein the integrity register index comprises a plurality of integrity register values; and a query module to receive a query from a client computing device, the query comprising a received integrity register value; compare the received integrity register value to the integrity register values of the integrity register index to identify a matching integrity register value; determine population data associated with the matching integrity register value, wherein the population data is indicative of a number of individuals having genomic sequence data corresponding to the matching integrity register value; and transmit the population data to the client computing device.

Example 18 includes the subject matter of Example 17, and wherein to generate the integrity register index comprises to concatenate a next element of the public genomic sequence data and a previous integrity register value to generate a concatenated value; and compute a next integrity register value as a cryptographic function of the concatenated value.

Example 19 includes the subject matter of any of Examples 17 and 18, and wherein to compute the next integrity register value comprises to apply a cryptographic hash function to the concatenated value.

Example 20 includes the subject matter of any of Examples 17-19, and wherein the index module is further to concatenate a second next element of the public genomic sequence data and the previous integrity register value to generate a second concatenated value, wherein the second next element is from a different branch of the public genomic sequence data than the next element; and compute a second next integrity register value as a cryptographic function of the second concatenated value.

Example 21 includes the subject matter of any of Examples 17-20, and wherein the query module is further to increment the population data in response to transmission of the population data to the client computing device.

Example 22 includes a computing device for genomic data management, the computing device comprising a query module to receive an integrity register value from a patient computing device, wherein the integrity register value is computed as a cryptographic function of genomic sequence data accessible by the patient computing device; and a compensation module to (i) transmit a compensation offer to the patient computing device in response to reception of the integrity register value and (ii) receive the genomic sequence data from the patient computing device in response to transmission of the compensation offer.

Example 23 includes the subject matter of Example 22, and further including a verification module to transmit the integrity register value received from the patient computing device to a public genomic database server; receive, from the public genome database server, population data indicative of a number of individuals having the genomic sequence data corresponding to the integrity register value in response to transmission of the integrity register value; and determine whether to transmit the compensation offer based on the population data; wherein to transmit the compensation offer comprises to transmit the compensation offer in response to a determination to transmit the compensation offer.

Example 24 includes the subject matter of any of Examples 22 and 23, and wherein to determine whether to transmit the compensation offer comprises to compare the population data to a predefined threshold population value.

Example 25 includes the subject matter of any of Examples 22-24, and wherein the query module is further to open an authenticated connection with the public genomic database server; and to transmit the integrity register value comprises to transmit the integrity register value received from the patient computing device to the public genomic database server via the authenticated connection.

Example 26 includes a method for genomic data management, the method comprising computing, by a trusted execution environment of a computing device, an integrity register value as a cryptographic function of genomic sequence data; transmitting, by the computing device, the integrity register value to a public genomic database server; receiving, by the computing device from the public genome database server and in response to transmitting the integrity register value, population data indicative of a number of individuals having the genomic sequence data corresponding to the integrity register value; and determining, by the computing device, whether to contribute the genomic sequence data to the public genomic database based on the population data.

Example 27 includes the subject matter of Example 26, and wherein computing the integrity register value comprises concatenating a next element of the genomic sequence data and a previous integrity register value to generate a concatenated value; and computing the integrity register value as a cryptographic function of the concatenated value.

Example 28 includes the subject matter of any of Examples 26 and 27, and wherein computing the integrity register value comprises applying a cryptographic hash function to the concatenated value.

Example 29 includes the subject matter of any of Examples 26-28, and wherein determining whether to contribute the genomic sequence data comprises comparing the population data to a predefined threshold population value.

Example 30 includes the subject matter of any of Examples 26-29, and further including computing, by the trusted execution environment of the computing device, a second integrity register value as a cryptographic function of second genomic sequence data, wherein the second genomic sequence data includes the genomic sequence data; transmitting, by the computing device, the second integrity register value to the public genomic database server; receiving, from the public genome database server and in response to transmitting the second integrity register value, second population data indicative of a number of individuals having the second genomic sequence data corresponding to the second integrity register value; and determining, by the computing device, whether to contribute the second genomic sequence data to the public genomic database based on the second population data, wherein determining whether to contribute the second genomic sequence data comprises comparing the second population data to the predefined threshold population value.

Example 31 includes the subject matter of any of Examples 26-30, and further including instructing, by the computing device, the public genomic database server to increment the population data associated with the integrity register value in response to determining to contribute the genomic sequence data to the public genomic database.

Example 32 includes the subject matter of any of Examples 26-31, and further including establishing, by the computing device, the trusted execution environment with a secure enclave of a processor of the computing device before computing the integrity register value.

Example 33 includes the subject matter of any of Examples 26-32, and further including establishing, by the computing device, the trusted execution environment with a security engine of the computing device before computing the integrity register value.

Example 34 includes the subject matter of any of Examples 26-33, and wherein the security engine comprises a trusted platform module.

Example 35 includes the subject matter of any of Examples 26-34, and wherein the security engine comprises a converged security and manageability engine.

Example 36 includes the subject matter of any of Examples 26-35, and further including opening, by the computing device, an authenticated connection with the public genomic database server; wherein transmitting the integrity register value to the public genomic database comprises transmitting the integrity register value via the authenticated connection.

Example 37 includes the subject matter of any of Examples 26-36, and wherein opening the authenticated connection comprises opening the authenticated connection using an encryption key protected by the trusted execution environment.

Example 38 includes the subject matter of any of Examples 26-37, and wherein the encryption key comprises an enhanced privacy identification (EPID) key.

Example 39 includes the subject matter of any of Examples 26-38, and further including transmitting, by the computing device, the integrity register value to a research database server; receiving, by the computing device, a compensation offer from the research database server in response to transmitting the integrity register value; determining, by the computing device, whether to accept the compensation offer; and transmitting, by the computing device, the genomic sequence data to the research database server in response to determining to accept the compensation offer.

Example 40 includes the subject matter of any of Examples 26-39, and wherein transmitting the genomic sequence data comprises transmitting the genomic sequence data by the trusted execution environment of the computing device.

Example 41 includes the subject matter of any of Examples 26-40, and further including opening, by the computing device, an authenticated connection with the research database server; wherein transmitting the genomic sequence data comprises transmitting the genomic sequence data via the authenticated connection.

Example 42 includes a method for genomic data management, the method comprising generating, by a computing device, an integrity register index as a cryptographic function of public genomic sequence data, wherein the integrity register index comprises a plurality of integrity register values; receiving, by the computing device, a query from a client computing device, the query comprising a received integrity register value; comparing, by the computing device, the received integrity register value to the integrity register values of the integrity register index to identify a matching integrity register value; determining, by the computing device, population data associated with the matching integrity register value, wherein the population data is indicative of a number of individuals having genomic sequence data corresponding to the matching integrity register value; and transmitting, by the computing device, the population data to the client computing device.

Example 43 includes the subject matter of Example 42, and wherein generating the integrity register index comprises concatenating a next element of the public genomic sequence data and a previous integrity register value to generate a concatenated value; and computing a next integrity register value as a cryptographic function of the concatenated value.

Example 44 includes the subject matter of any of Examples 42 and 43, and wherein computing the next integrity register value comprises applying a cryptographic hash function to the concatenated value.

Example 45 includes the subject matter of any of Examples 42-44, and further including concatenating, by the computing device, a second next element of the public genomic sequence data and the previous integrity register value to generate a second concatenated value, wherein the second next element is from a different branch of the public genomic sequence data than the next element; and computing, by the computing device, a second next integrity register value as a cryptographic function of the second concatenated value.

Example 46 includes the subject matter of any of Examples 42-45, and further including incrementing, by the computing device, the population data in response to transmitting the population data to the client computing device.

Example 47 includes a method for genomic data management, the method comprising receiving, by a computing device, an integrity register value from a patient computing device, wherein the integrity register value is computed as a cryptographic function of genomic sequence data accessible by the patient computing device; transmitting, by the computing device, a compensation offer to the patient computing device in response to receiving the integrity register value; and receiving, by the computing device, the genomic sequence data from the patient computing device in response to transmitting the compensation offer.

Example 48 includes the subject matter of Example 47, and further including transmitting, by the computing device, the integrity register value received from the patient computing device to a public genomic database server; receiving, by the computing device from the public genome database server, population data indicative of a number of individuals having the genomic sequence data corresponding to the integrity register value in response to transmitting the integrity register value; and determining, by the computing device, whether to transmit the compensation offer based on the population data; wherein transmitting the compensation offer comprises transmitting the compensation offer in response to determining to transmit the compensation offer.

Example 49 includes the subject matter of any of Examples 47 and 48, and wherein determining whether to transmit the compensation offer comprises comparing the population data to a predefined threshold population value.

Example 50 includes the subject matter of any of Examples 47-49, and further including opening, by the computing device, an authenticated connection with the public genomic database server; wherein transmitting the integrity register value comprises transmitting the integrity register value received from the patient computing device to the public genomic database server via the authenticated connection.

Example 51 includes a computing device comprising a processor; and a memory having stored therein a plurality of instructions that when executed by the processor cause the computing device to perform the method of any of Examples 26-50.

Example 52 includes one or more machine readable storage media comprising a plurality of instructions stored thereon that in response to being executed result in a computing device performing the method of any of Examples 26-50.

Example 53 includes a computing device comprising means for performing the method of any of Examples 26-50.

Example 54 includes a computing device for genomic data management, the computing device comprising means for computing, by a trusted execution environment of the computing device, an integrity register value as a cryptographic function of genomic sequence data; means for transmitting the integrity register value to a public genomic database server; means for receiving, from the public genome database server and in response to transmitting the integrity register value, population data indicative of a number of individuals having the genomic sequence data corresponding to the integrity register value; and means for determining whether to contribute the genomic sequence data to the public genomic database based on the population data.

Example 55 includes the subject matter of Example 54, and wherein computing the integrity register value comprises concatenating a next element of the genomic sequence data and a previous integrity register value to generate a concatenated value; and computing the integrity register value as a cryptographic function of the concatenated value.

Example 56 includes the subject matter of any of Examples 54 and 55, and wherein the means for computing the integrity register value comprises means for applying a cryptographic hash function to the concatenated value.

Example 57 includes the subject matter of any of Examples 54-56, and wherein the means for determining whether to contribute the genomic sequence data comprises means for comparing the population data to a predefined threshold population value.

Example 58 includes the subject matter of any of Examples 54-57, and further including means for computing, by the trusted execution environment, a second integrity register value as a cryptographic function of second genomic sequence data, wherein the second genomic sequence data includes the genomic sequence data; means for transmitting the second integrity register value to the public genomic database server; means for receiving, from the public genome database server and in response to transmitting the second integrity register value, second population data indicative of a number of individuals having the second genomic sequence data corresponding to the second integrity register value; and means for determining whether to contribute the second genomic sequence data to the public genomic database based on the second population data, wherein the means for determining whether to contribute the second genomic sequence data comprises means for comparing the second population data to the predefined threshold population value.

Example 59 includes the subject matter of any of Examples 54-58, and further including means for instructing the public genomic database server to increment the population data associated with the integrity register value in response to determining to contribute the genomic sequence data to the public genomic database.

Example 60 includes the subject matter of any of Examples 54-59, and further including means for establishing the trusted execution environment with a secure enclave of a processor of the computing device before computing the integrity register value.

Example 61 includes the subject matter of any of Examples 54-60, and further including means for establishing the trusted execution environment with a security engine of the computing device before computing the integrity register value.

Example 62 includes the subject matter of any of Examples 54-61, and wherein the security engine comprises a trusted platform module.

Example 63 includes the subject matter of any of Examples 54-62, and wherein the security engine comprises a converged security and manageability engine.

Example 64 includes the subject matter of any of Examples 54-63, and further including means for opening an authenticated connection with the public genomic database server; wherein the means for transmitting the integrity register value to the public genomic database comprises means for transmitting the integrity register value via the authenticated connection.

Example 65 includes the subject matter of any of Examples 54-64, and wherein the means for opening the authenticated connection comprises means for opening the authenticated connection using an encryption key protected by the trusted execution environment.

Example 66 includes the subject matter of any of Examples 54-65, and wherein the encryption key comprises an enhanced privacy identification (EPID) key.

Example 67 includes the subject matter of any of Examples 54-66, and further including means for transmitting the integrity register value to a research database server; means for receiving a compensation offer from the research database server in response to transmitting the integrity register value; means for determining whether to accept the compensation offer; and means for transmitting the genomic sequence data to the research database server in response to determining to accept the compensation offer.

Example 68 includes the subject matter of any of Examples 54-67, and wherein the means for transmitting the genomic sequence data comprises means for transmitting the genomic sequence data by the trusted execution environment of the computing device.

Example 69 includes the subject matter of any of Examples 54-68, and further including means for opening an authenticated connection with the research database server; wherein the means for transmitting the genomic sequence data comprises means for transmitting the genomic sequence data via the authenticated connection.

Example 70 includes a computing device for genomic data management, the computing device comprising means for generating an integrity register index as a cryptographic function of public genomic sequence data, wherein the integrity register index comprises a plurality of integrity register values; means for receiving a query from a client computing device, the query comprising a received integrity register value; means for comparing the received integrity register value to the integrity register values of the integrity register index to identify a matching integrity register value; means for determining population data associated with the matching integrity register value, wherein the population data is indicative of a number of individuals having genomic sequence data corresponding to the matching integrity register value; and means for transmitting the population data to the client computing device.

Example 71 includes the subject matter of Example 70, and wherein the means for generating the integrity register index comprises means for concatenating a next element of the public genomic sequence data and a previous integrity register value to generate a concatenated value; and means for computing a next integrity register value as a cryptographic function of the concatenated value.

Example 72 includes the subject matter of any of Examples 70 and 71, and wherein the means for computing the next integrity register value comprises means for applying a cryptographic hash function to the concatenated value.

Example 73 includes the subject matter of any of Examples 70-72, and further including means for concatenating a second next element of the public genomic sequence data and the previous integrity register value to generate a second concatenated value, wherein the second next element is from a different branch of the public genomic sequence data than the next element; and means for computing a second next integrity register value as a cryptographic function of the second concatenated value.

Example 74 includes the subject matter of any of Examples 70-73, and further including means for incrementing the population data in response to transmitting the population data to the client computing device.

Example 75 includes a computing device for genomic data management, the computing device comprising means for receiving an integrity register value from a patient computing device, wherein the integrity register value is computed as a cryptographic function of genomic sequence data accessible by the patient computing device; means for transmitting a compensation offer to the patient computing device in response to receiving the integrity register value; and means for receiving the genomic sequence data from the patient computing device in response to transmitting the compensation offer.

Example 76 includes the subject matter of Example 75, and further including means for transmitting the integrity register value received from the patient computing device to a public genomic database server; means for receiving, from the public genome database server, population data indicative of a number of individuals having the genomic sequence data corresponding to the integrity register value in response to transmitting the integrity register value; and means for determining whether to transmit the compensation offer based on the population data; wherein the means for transmitting the compensation offer comprises means for transmitting the compensation offer in response to determining to transmit the compensation offer.

Example 77 includes the subject matter of any of Examples 75 and 76, and wherein the means for determining whether to transmit the compensation offer comprises means for comparing the population data to a predefined threshold population value.

Example 78 includes the subject matter of any of Examples 75-77, and further including means for opening an authenticated connection with the public genomic database server; wherein the means for transmitting the integrity register value comprises means for transmitting the integrity register value received from the patient computing device to the public genomic database server via the authenticated connection.

1. A computing device for genomic data management, the computing device comprising:
an integrity register computation module to compute, in a trusted execution environment, an integrity register value as a cryptographic function of genomic sequence data;
a query module to (i) transmit the integrity register value to a public genomic database server and (ii) receive, from the public genome database server and in response to transmission of the integrity register value, population data indicative of a number of individuals having the genomic sequence data corresponding to the integrity register value; and
a privacy module to determine whether to contribute the genomic sequence data to the public genomic database based on the population data.

2. The computing device of claim 1, wherein to compute the integrity register value comprises to:
concatenate a next element of the genomic sequence data and a previous integrity register value to generate a concatenated value; and
compute the integrity register value as a cryptographic function of the concatenated value.

3. The computing device of claim 1, wherein to determine whether to contribute the genomic sequence data comprises to compare the population data to a predefined threshold population value.

4. The computing device of claim 3, wherein:
the integrity register computation module is further to compute a second integrity register value as a cryptographic function of second genomic sequence data, wherein the second genomic sequence data includes the genomic sequence data;
the query module is further to (i) transmit the second integrity register value to the public genomic database server and (ii) receive, from the public genome database server and in response to transmission of the second integrity register value, second population data indicative of a number of individuals having the second genomic sequence data corresponding to the second integrity register value; and
the privacy module is further to determine whether to contribute the second genomic sequence data to the public genomic database based on the second population data, wherein to determine whether to contribute the second genomic sequence data comprises to compare the second population data to the predefined threshold population value.

5. The computing device of claim 1, further comprising a processor having a secure enclave, the secure enclave to establish the trusted execution environment.

6. The computing device of claim 1, further comprising a security engine to establish the trusted execution environment.

7. The computing device of claim 6, wherein the security engine comprises a trusted platform module.

8. The computing device of claim 6, wherein the security engine comprises a converged security and manageability engine.

9. The computing device of claim 1, wherein:
the query module is further to open an authenticated connection with the public genomic database server using an encryption key protected by the trusted execution environment; and
to transmit the integrity register value to the public genomic database comprises to transmit the integrity register value via the authenticated connection.

10. The computing device of claim 9, wherein the encryption key comprises an enhanced privacy identification (EPID) key.

11. The computing device of claim 1, further comprising a compensation module to:
receive a compensation offer from a research database server;
determine whether to accept the compensation offer; and
transmit the genomic sequence data to the research database server in response to a determination to accept the compensation offer;
wherein the query module is further to transmit the integrity register value to the research database server.

12. The computing device of claim 11, wherein to transmit the genomic sequence data comprises to transmit the genomic sequence data by the trusted execution environment of the computing device.

13. One or more computer-readable storage media comprising a plurality of instructions that in response to being executed cause a computing device to:
compute, by a trusted execution environment of the computing device, an integrity register value as a cryptographic function of genomic sequence data;
transmit the integrity register value to a public genomic database server;
receive, from the public genome database server and in response to transmitting the integrity register value, population data indicative of a number of individuals having the genomic sequence data corresponding to the integrity register value; and
determine whether to contribute the genomic sequence data to the public genomic database based on the population data.

14. The one or more computer-readable storage media of claim 13, wherein to compute the integrity register value comprises to:
concatenate a next element of the genomic sequence data and a previous integrity register value to generate a concatenated value; and
compute the integrity register value as a cryptographic function of the concatenated value.

15. The one or more computer-readable storage media of claim 13, wherein to determine whether to contribute the genomic sequence data comprises to compare the population data to a predefined threshold population value.

16. The one or more computer-readable storage media of claim 13, further comprising a plurality of instructions that in response to being executed cause the computing device to open an authenticated connection with the public genomic database server using an encryption key protected by the trusted execution environment;
wherein to transmit the integrity register value to the public genomic database comprises to transmit the integrity register value via the authenticated connection.

17. The one or more computer-readable storage media of claim 13, further comprising a plurality of instructions that in response to being executed cause the computing device to:
transmit the integrity register value to a research database server;
receive a compensation offer from the research database server in response to transmitting the integrity register value;
determine whether to accept the compensation offer; and
transmit the genomic sequence data to the research database server in response to determining to accept the compensation offer.

18. The one or more computer-readable storage media of claim 17, wherein to transmit the genomic sequence data comprises to transmit the genomic sequence data by the trusted execution environment of the computing device.

19. A computing device for genomic data management, the computing device comprising:
an index module to generate an integrity register index as a cryptographic function of public genomic sequence data, wherein the integrity register index comprises a plurality of integrity register values; and
a query module to:
receive a query from a client computing device, the query comprising a received integrity register value;
compare the received integrity register value to the integrity register values of the integrity register index to identify a matching integrity register value;
determine population data associated with the matching integrity register value, wherein the population data is indicative of a number of individuals having genomic sequence data corresponding to the matching integrity register value; and
transmit the population data to the client computing device.

20. The computing device of claim 19, wherein to generate the integrity register index comprises to:
concatenate a next element of the public genomic sequence data and a previous integrity register value to generate a concatenated value; and
compute a next integrity register value as a cryptographic function of the concatenated value.

21. The computing device of claim 20, wherein the index module is further to:
concatenate a second next element of the public genomic sequence data and the previous integrity register value to generate a second concatenated value, wherein the second next element is from a different branch of the public genomic sequence data than the next element; and
compute a second next integrity register value as a cryptographic function of the second concatenated value.

22. The computing device of claim 19, wherein the query module is further to increment the population data in response to transmission of the population data to the client computing device.

23. One or more computer-readable storage media comprising a plurality of instructions that in response to being executed cause a computing device to:
generate an integrity register index as a cryptographic function of public genomic sequence data, wherein the integrity register index comprises a plurality of integrity register values;
receive a query from a client computing device, the query comprising a received integrity register value;
compare the received integrity register value to the integrity register values of the integrity register index to identify a matching integrity register value;
determine population data associated with the matching integrity register value, wherein the population data is indicative of a number of individuals having genomic sequence data corresponding to the matching integrity register value; and
transmit the population data to the client computing device.

24. The one or more computer-readable storage media of claim 23, wherein to generate the integrity register index comprises to:
concatenate a next element of the public genomic sequence data and a previous integrity register value to generate a concatenated value; and
compute a next integrity register value as a cryptographic function of the concatenated value.

25. The one or more computer-readable storage media of claim 24, further comprising a plurality of instructions that in response to being executed cause the computing device to:
concatenate a second next element of the public genomic sequence data and the previous integrity register value to generate a second concatenated value, wherein the second next element is from a different branch of the public genomic sequence data than the next element; and
compute a second next integrity register value as a cryptographic function of the second concatenated value.
